(19) United States
(12) Patent Application Publication
(10) Pub. No.: US 2014/0109696 A1
(43) Pub. Date: Apr. 24, 2014

(54) PRESSURE SENSING DEVICE AND CLIPPING APPARATUS USING THE SAME

(71) Applicant: INDUSTRIAL TECHNOLOGY RESEARCH INSTITUTE, Chutung (TW)

(72) Inventors: Chang-Yi CHEN, Hsinchu City (TW); Wen-Ching KO, Kaohsiung City (TW); Kuo-Hua TSENG, New Taipei City (TW)

(73) Assignee: INDUSTRIAL TECHNOLOGY RESEARCH INSTITUTE, Chutung (TW)

(21) Appl. No.: 13/678,325

(22) Filed: Nov. 15, 2012

(30) Foreign Application Priority Data
Oct. 18, 2012 (TW) 101138474

(51) Int. Cl. G01L 1/00

(52) U.S. Cl. CPC G01L 1/00
USPC 73/862.541; 73/862.381

(57) ABSTRACT

A pressure sensing device and a clipping apparatus using the same are provided. The pressure sensing device includes a pressure sensing layer and a bump structure. The bump structure is disposed at one side of the pressure sensing layer. A parallel cross-sectional plane of the bump structure gradually becomes small along a direction. The parallel cross-sectional plane is substantially parallel to the pressure sensing layer.

This application claims the benefit of Taiwan application Serial No. 101138474, filed Oct. 18, 2012, the disclosure of which is incorporated by reference herein in its entirety.

### TECHNICAL FIELD

The disclosure relates in general to a sensing device and a clipping apparatus using the same, and more particularly to a pressure sensing device and a clipping apparatus using the same.

### BACKGROUND

Currently, pressure sensing technology has been widely used in various fields of engineering. However, existing pressure sensors are not sensitive enough for recognizing micro force sensing such as the sensing area being smaller than 2×2 mm and the pressure being smaller than 10 psi. When existing pressure sensors are used for sensing a micro force or sensing the clipping force applied on a soft object, the existing pressure sensors will have deteriorated performance and cannot provide practical use.

### SUMMARY

The disclosure is directed to a pressure sensing device and a clipping apparatus using the same.

According to one embodiment, a pressure sensing device is provided. The pressure sensing device comprises a pressure sensing layer and a bump structure. The bump structure is disposed at one side of the pressure sensing layer. A parallel cross-sectional plane of the bump structure gradually becomes small along a direction. The parallel cross-sectional plane is substantially parallel to the pressure sensing layer.

According to another embodiment, a clipping apparatus is provided. The clipping apparatus comprises a clip, a plurality of pressure sensing devices and a control unit. The pressure sensing device is disposed on the clip. Each pressure sensing device comprises a pressure sensing layer and a bump structure. The bump structure is disposed at one side of the pressure sensing layer. A parallel cross-sectional plane of the bump structure gradually becomes small along a direction. The parallel cross-sectional plane is substantially parallel to the pressure sensing layer. The control unit controls a clipping force of the clip according to a plurality of pressure signals of the pressure sensing devices.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of a pressure sensing device;

FIG. 2 shows a schematic diagram of a pressure sensing device of another embodiment;

FIG. 3 shows a schematic diagram of a pressure distribution curve;

FIG. 4 shows a schematic diagram of a conductance vs. force relationship curve;

FIG. 5 shows a schematic diagram of a pressure sensing device of another embodiment;

FIG. 6 shows a schematic diagram of a pressure sensing device of another embodiment;

FIGS. 7 to 8 respectively show a schematic diagram of a pressure sensing device of other embodiments;

FIG. 9 shows a schematic diagram of a pressure sensing device of another embodiment;

FIG. 10 shows a schematic diagram of a pressure sensing device of another embodiment;

FIGS. 11 to 12 respectively show a schematic diagram of a clipping apparatus;

FIG. 13 shows a disposition diagram of a plurality of pressure sensing devices.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

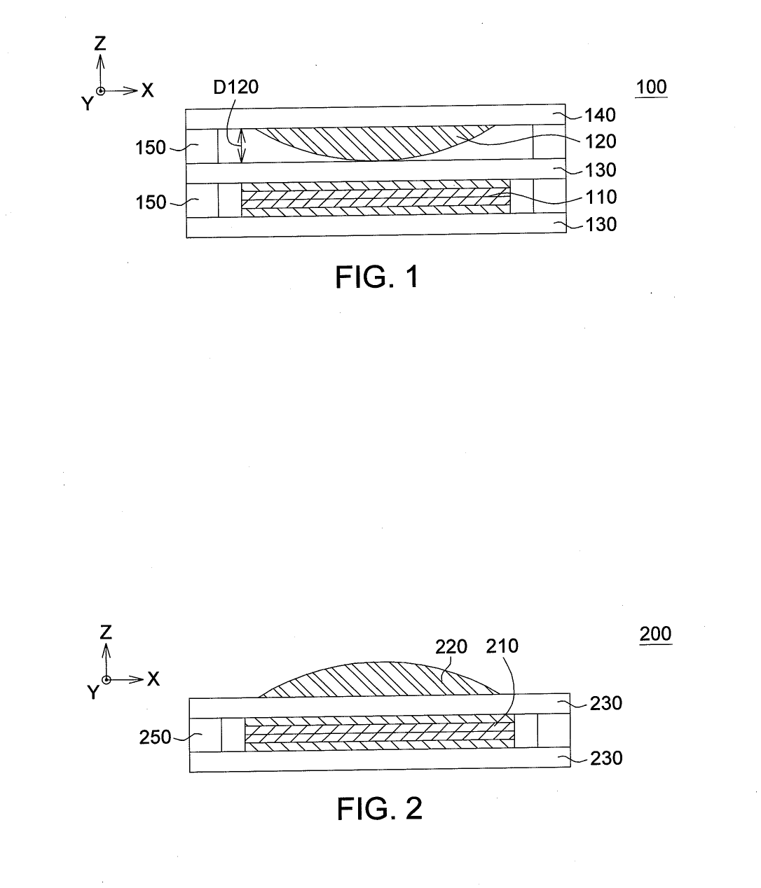

Referring to FIG. 1, a schematic diagram of a pressure sensing device 100 is shown. The pressure sensing device 100 comprises a pressure sensing layer 110 and a bump structure 120. The pressure sensing layer 110 can be a pressure sensor device, such as a resistive pressure sensor device, a piezoelectric pressure sensor device, a capacitive pressure sensor device, or a magnetic pressure sensor device.

The bump structure 120 is disposed at one side of the pressure sensing layer 110. A parallel cross-sectional plane of the bump structure 120 gradually becomes small along a direction towards the pressure sensing layer 110. The parallel cross-sectional plane, such as the X-Y cross-section, is substantially parallel to the pressure sensing layer 110.

The surface of the bump structure 120 can be smooth or rough. The bump structure 120 can be formed by such as a hard material or a soft material. The bump structure 120 can be formed by a dripping process, an UV-light curing process or a thermal curing process.

The parallel cross-sectional plane of the bump structure 120 gradually becomes small along a direction towards the pressure sensing layer 110. As indicated in FIG. 1, a vertical cross-section of the bump structure 120, such as the X-Z cross-section, is arced and substantially perpendicular to the pressure sensing layer 110. The thickness of D120 of the bump structure 120 is less than 200 micrometers (μm), and is between 100 to 200 micrometer (μm). The vertex of the bump structure 120 faces the pressure sensing layer 110. When a pressure is applied to the bump structure 120 of the pressure sensing device 100, the pressure is transmitted to the pressure sensing layer 110 from the bump structure 120 and is concentrated at a smaller area (such as the vertex of the bump structure 120), so that the sensitivity in pressure sensing is increased and the sensed pressure signal is amplified.

As indicated in FIG. 1, the pressure sensing device 100 further comprises two sandwich boards 130, a supporting board 140 and at least one flexible structure 150. The pressure sensing layer 110 is disposed between the sandwich boards 130 and the sandwich boards 130 are flexible substrates. A signal line is disposed between the sandwich board 130 and the pressure sensing layer 110 for transmitting the pressure signals received on the signal line. The bump structure 120 is disposed on the supporting board 140. The supporting board 140 can be such as a plastic board, a glass board or an acrylic board. The flexible structure 150 is disposed between the sandwich boards 130 and is disposed between one of the sandwich boards 130 and the supporting board 140. The flexible structure 150 can be a ring-shaped structure disposed at the edge of the sandwich board 130.

When a pressure is applied to the pressure sensing device 100, the supporting board 140 is pressed and squeezes the bump structure 120 towards the pressure sensing layer 110. The sandwich board 130 being continuously squeezed by the bump structure 120 is deformed and accordingly squeezes the pressure sensing layer 110. After the pressure sensing layer 110 is squeezed, the magnitude of pressure may be measured according to the degree of squeezing. During the course of applying a pressure, the flexible structure 150 may be deformed so that the bump structure 120 may smoothly squeeze one of the sandwich boards 130 towards the pressure sensing layer 110.

Referring to FIG. 2, a schematic diagram of a pressure sensing device 200 of another embodiment is shown. A parallel cross-sectional plane (such as the X-Y cross-section) of the bump structure 220 gradually becomes small along a direction backwards the pressure sensing layer 210. A vertical cross-section (such as X-Z cross-section) of the bump structure 220a is arced.

The vertex of the bump structure 220 faces the pressure-receiving part. When a pressure is applied to the bump structure 220 of the pressure sensing device 200, the pressure is transmitted to the pressure sensing layer 210 from the bump structure 220 and can be concentrated at a smaller area (such as the vertex of the bump structure 220), and is concentrated at a smaller area (such as the vertex of the bump structure 220) instead of the entire sandwich board 230, so that the sensitivity in pressure sensing is increased and the sensed pressure signal is amplified.

As indicated in FIG. 2, the pressure sensing layer device 200 does not includes the supporting board 140 of FIG. 1, and the bump structure 220 is directly disposed on one of the sandwich boards 230. The flexible structure 250 is disposed between two sandwich boards 230.

When a pressure is applied to the pressure sensing device 200, the supporting board 140 is pressed and squeezes the bump structure 220 towards the pressure sensing layer 210. The sandwich board 230 being continuously squeezed by the bump structure 220 is deformed and squeezes the pressure sensing layer 210. After the pressure sensing layer 210 is squeezed, the magnitude of pressure may be measured according to the degree of squeezing. During the course of applying a pressure, the flexible structure 250 may be deformed so that the bump structure 220 may smoothly squeeze one of the sandwich boards 230 towards the pressure sensing layer 210.

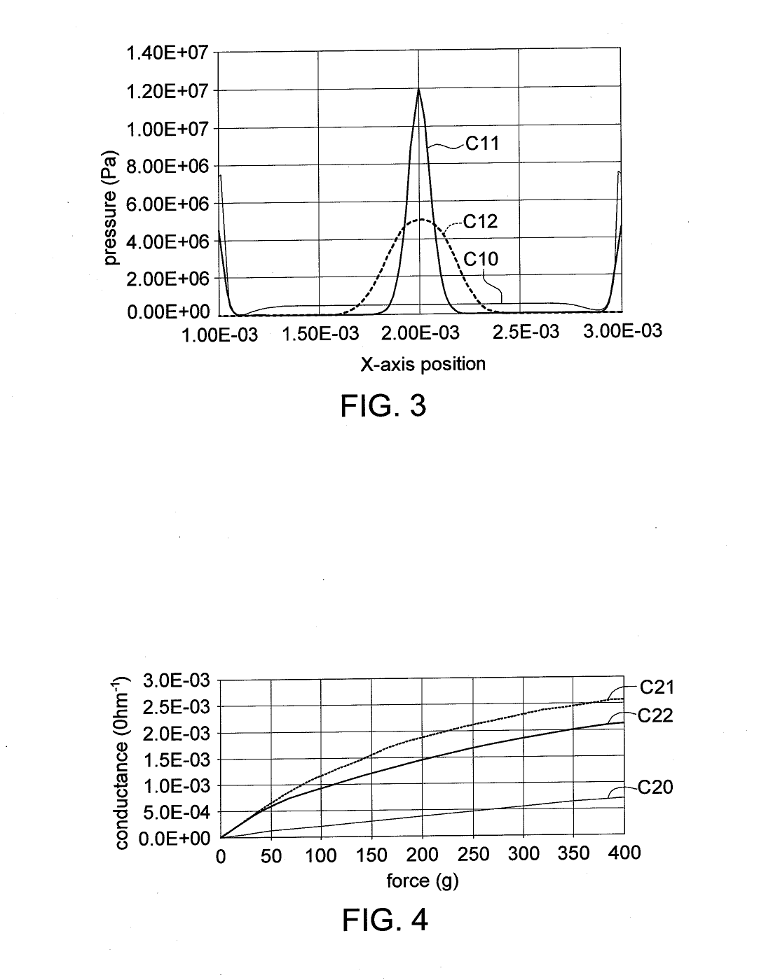

Referring to FIG. 3, a schematic diagram of a pressure distribution curves C10, C11 and C12 is shown. The pressure distribution curve C10 denotes a pressure distribution of a pressure sensing device (not illustrated) not having a bump structure. The pressure distribution curve C11 denotes a pressure distribution of the pressure sensing device 100 of FIG. 1. The pressure distribution curve C12 denotes a pressure distribution of the pressure sensing device 200 of FIG. 2. The pressure distribution curve C10 shows that pressure is uniformly distributed on the entire sandwich board of the pressure sensing device not having a bump structure. The pressure distribution curves C11 and C12 show that pressure is concentrated near the center of the pressure sensing devices 100 and 200 of FIGS. 1 to 2 respectively. In comparison to the pressure sensing device not having a bump structure, pressure is sensed more sensitively at the center of the pressure sensing devices 100 and 200 having bump structures 120 and 220 respectively.

Referring to FIG. 4, a schematic diagram of conductance vs. force relationship curves C20, C21 and C22 is shown. The relationship curve C20 denotes a conductance vs. force relationship of a pressure sensing device (not illustrated) not having a bump structure. The relationship curve of C21 denotes a conductance vs. force relationship of the pressure sensing device 100 of FIG. 1. The relationship curve of C22 denotes a conductance vs. force relationship of the pressure sensing device 200 of FIG. 2. The comparison of the relationship curves C20, C21 and C22 as illustrated in FIG. 4 shows that the relationship curves C20 has the lowest rate of change for conductance with respect to force, the relationship curve of C22 has the second lowest rate of change, and the relationship curve of C21 has the highest rate of change. In comparison to the pressure sensing device not having a bump structure, the pressure sensing devices 100 and 200 having bump structures 120 and 220 respectively have higher conductance sensitivity. The pressure sensing devices 100 and 200 of FIGS. 1 and 2 respectively may sense amplified pressure signals and are applicable to micro force sensing.

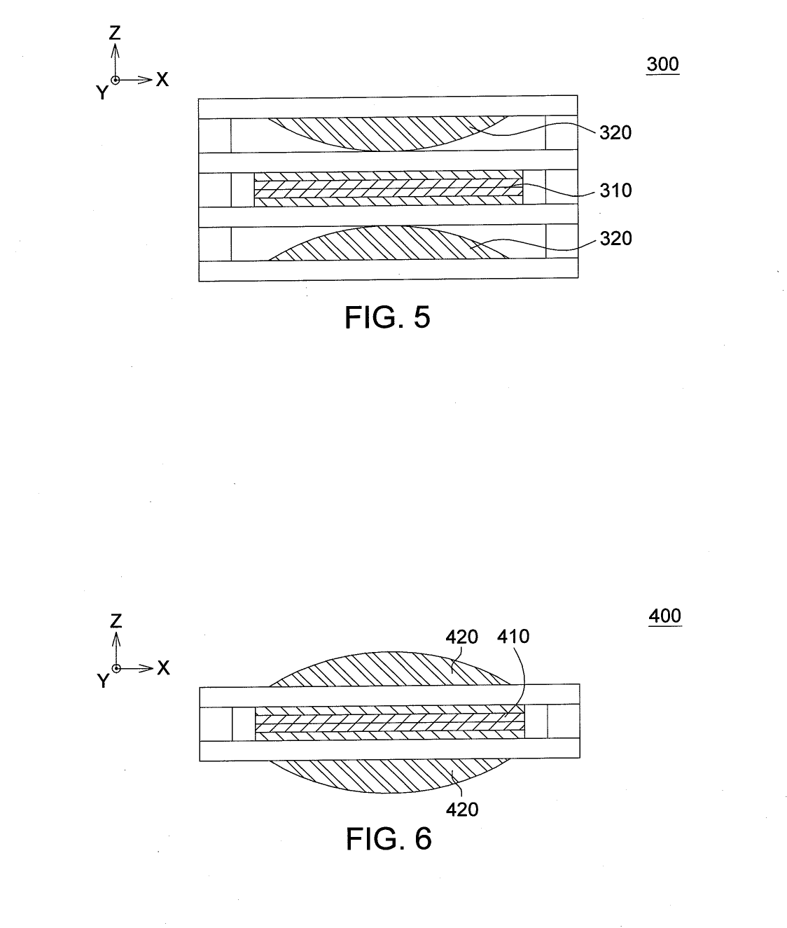

Referring to FIG. 5, a schematic diagram of a pressure sensing device 300 of another embodiment is shown. In the pressure sensing device 300, the quantity of bump structures 320 is exemplified by two. Two bump structures 320 are respectively disposed at two sides of the pressure sensing layer 310. The parallel cross-sectional planes (such as the X-Y cross-section) of the two bump structure 320 both gradually become small along directions towards the pressure sensing layer 310.

Referring to FIG. 6, a schematic diagram of a pressure sensing device 400 of another embodiment is shown. In the pressure sensing device 400, the quantity of bump structures 420 is exemplified by two. Two bump structures 420 are respectively disposed at two sides of the pressure sensing layer 410. The parallel cross-sectional planes (such as the X-Y cross-section) of the two bump structures 420 both gradually become along directions backwards the pressure sensing layer 410.

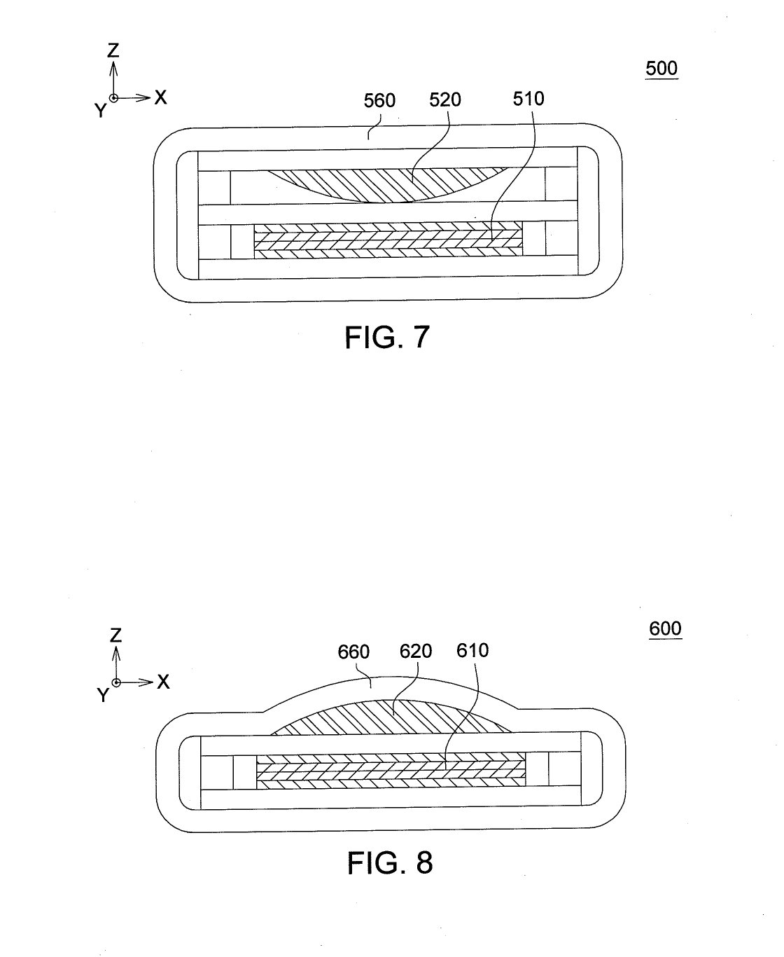

Referring to FIGS. 7 to 8, schematic diagrams of pressure sensing devices 500 and 600 of other embodiments are respectively shown. The pressure sensing devices 500 and 600 further comprise seal structures 560 and 660 respectively. The seal structures 560 and 660 respectively cover the pressure sensing layers 510 and 610 as well as the bump structures 520 and 620. The seal structures 560 and 660, realized by such as a plastic film or a plastic casing, may provide a pre-pressure to the pressure sensing layers 510 and 610 and can prevent the pressure sensing layers 510 and 610 from being damaged by micro-particles or moisture. As indicated in FIG. 4, when the seal structures 560 and 660 provide a 150 g pre-force, corresponding conductance levels of the three relationship curves C20, C21 and C22 are 0.7E−04 Ohm⁻¹, 1.2E−04 Ohm⁻¹, 1.6E−04 Ohm⁻¹ respectively. Thus, the conductance will vary with the force more sensitively.

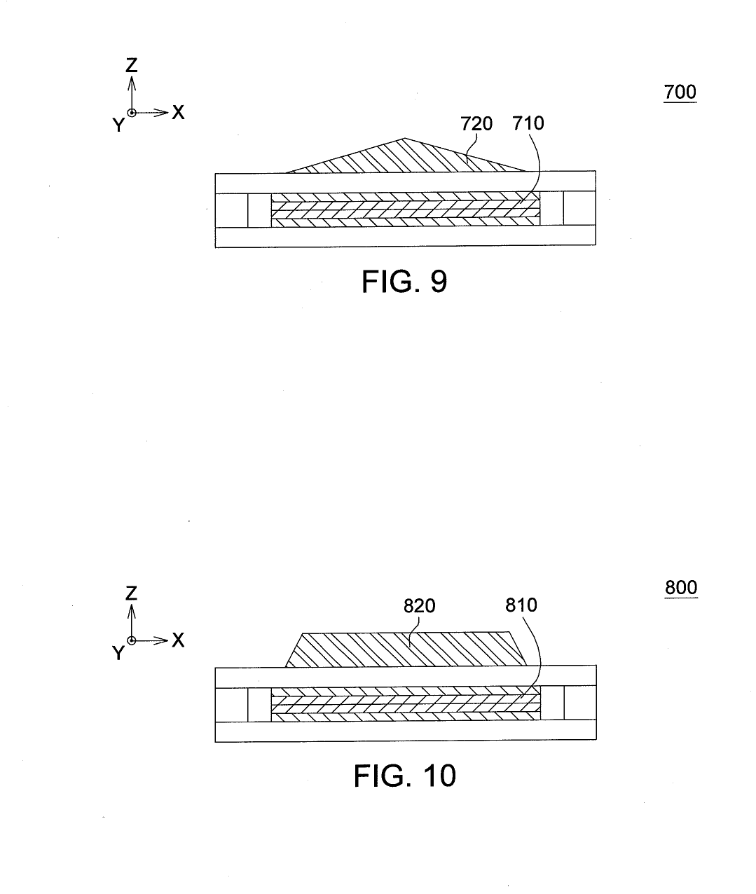

Referring to FIG. 9, a schematic diagram of a pressure sensing device 700 of another embodiment is shown. In the pressure sensing device 700, a vertical cross-section (such as X-Z cross-section) of the bump structure 720 is wedge-shaped. The parallel cross-sectional plane (such as the X-Y cross-section) of the wedge-shaped bump structure 720 gradually becomes small along a direction towards the pressure sensing layer 710.

Referring to FIG. 10, a schematic diagram of a pressure sensing device 800 of another embodiment is shown. In the pressure sensing device 800, a vertical cross-section (such as the X-Z cross-section) of the bump structure 820 is trapezoidal. The parallel cross-sectional plane (such as X-Y cross-section) of the trapezoidal bump structure 820 gradually becomes small along a direction towards the pressure sensing layer 810.

The pressure sensing devices 100 and 200, 300, 400, 500, 600, 700, and 800 may have different combinations. For example, in another embodiment, the pressure sensing device may be formed by a wedge-shaped bump structure and a trapezoidal bump structure.

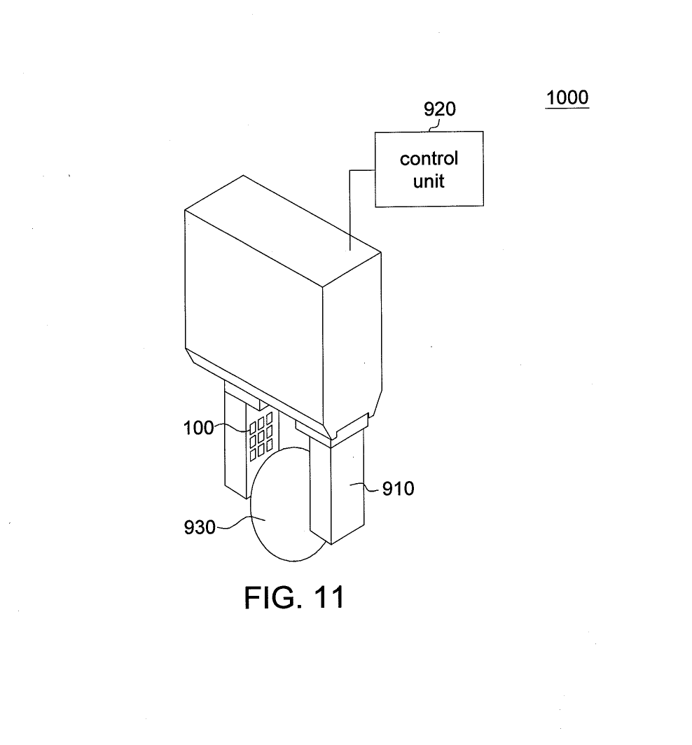

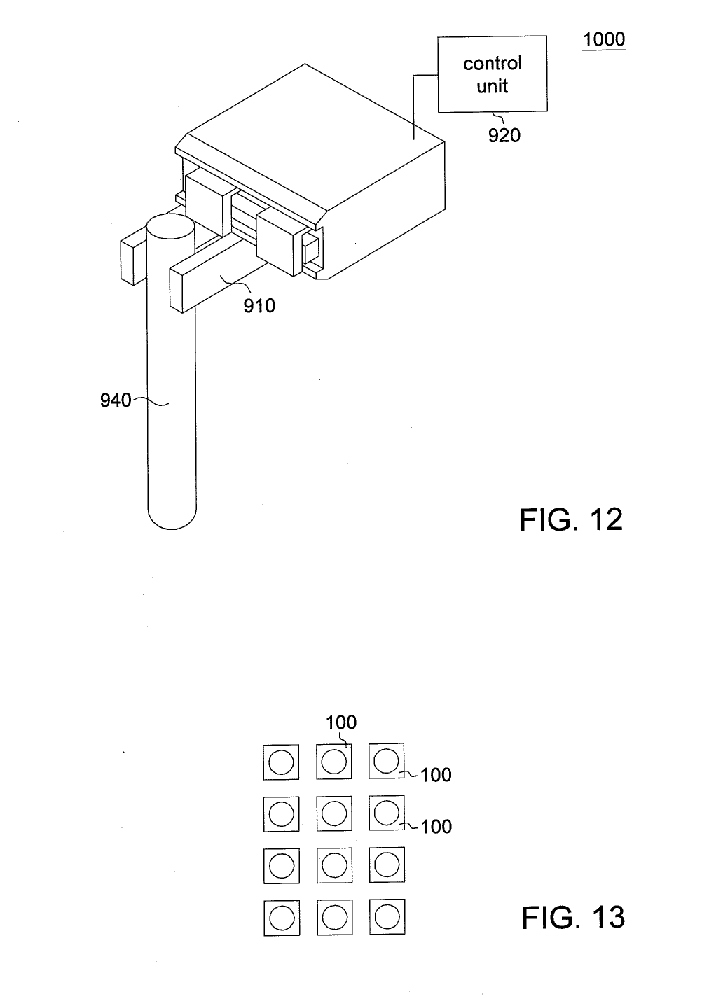

Referring to FIGS. 11 to 12, schematic diagrams of a clipping apparatus 1000 are respectively shown. The pressure sensing devices 100 and 200, 300, 400, 500, 600, 700, and 800 may be used in a clipping apparatus 1000. For example, the clipping apparatus 1000 comprises a clip 910, a plurality of pressure sensing devices 100 and a control unit 920. The pressure sensing device 100 is disposed on the clip 910. When the clip 910 clamps a fragile object (such as an egg 930 of FIG. 11 or a glass tube 940 of FIG. 12), the pressure sensing device 100 directly contacts the object. The pressure sensing device 100 may sense the reaction force generated by an object being clamped, and further transmit a plurality of pressure signals to the control unit 920. Then, the control unit 920 fine-tunes the clipping force applied on the clip 910 according to pressure signals to avoid the object being damaged by an excessive clipping force.

Referring to FIG. 13, a disposition diagram of a plurality of pressure sensing devices 100 is shown. The pressure sensing device 100 may be disposed on the clip 910 in the form of a matrix, and has a bionic feature similar to the skin texture of a reptile. In addition, when the sandwich boards 130 of the pressure sensing device 100 are formed by a flexible substrate, the pressure sensing device 100 may be adapted to the shape of the clip 910.

Through the bump structure 120 (illustrated in FIG. 1), the pressure sensing device 100 may amplify and transmit the sensed pressure signals to the control unit 920. Then, the control unit 920 may analyze the magnitude of the reaction force received by the clip 910. Therefore, an appropriate clipping force may be precisely adjusted for a fragile object.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A pressure sensing device, comprising:
a pressure sensing layer; and
at least one bump structure disposed at one side of the pressure sensing layer, wherein a parallel cross-sectional plane of the bump structure gradually becomes small along a direction, and the parallel cross-sectional plane is substantially parallel to the pressure sensing layer.

2. The pressure sensing device according claim 1, wherein the parallel cross-sectional plane of the bump structure gradually becomes small along a direction towards the pressure sensing layer.

3. The pressure sensing device according claim 1, wherein the parallel cross-sectional plane of the bump structure gradually becomes small along a direction backwards the pressure sensing layer.

4. The pressure sensing device according claim 1, wherein a thickness of the bump structure is less than 200 micrometers (μm).

5. The pressure sensing device according claim 1, wherein a vertical cross-section of the bump structure is arced, wedge-shaped or trapezoidal, and the vertical cross-section is substantially perpendicular to the pressure sensing layer.

6. The pressure sensing device according claim 1, wherein the quantity of the at least one bump structure is two, and the bump structures respectively are disposed at two sides of the pressure sensing layer.

7. The pressure sensing device according claim 1, further comprising:
two sandwich boards, wherein the pressure sensing layer is disposed between the two sandwich boards; and
a supporting board, wherein the bump structure is disposed on the supporting board, and the parallel cross-sectional plane of the bump structure gradually becomes small towards the pressure sensing layer.

8. The pressure sensing device according claim 7, wherein the sandwich boards are flexible substrates.

9. The pressure sensing device according claim 7, further comprising:
at least one flexible structure disposed between the sandwich boards and disposed between one of the sandwich boards and the supporting board.

10. The pressure sensing device according claim 1, further comprising:
two sandwich boards, wherein the pressure sensing layer is disposed between the sandwich boards, the bump structure is disposed on one of the sandwich board, and the parallel cross-sectional plane of the bump structure gradually becomes small along a direction backwards the pressure sensing layer.

11. The pressure sensing device according claim 10, wherein the sandwich boards are flexible substrates.

12. The pressure sensing device according claim 10, further comprising:
at least one flexible structure disposed between the sandwich boards.

13. The pressure sensing device according claim 1, further comprising:
a seal structure covering the pressure sensing layer and the bump structure.

14. A clipping apparatus, comprising:
a clip;
a plurality of the pressure sensing devices disposed on the clip, wherein each pressure sensing device comprises:
a pressure sensing layer; and
at least one bump structure disposed at one side of the pressure sensing layer, wherein a parallel cross-sectional plane of the bump structure gradually becomes small along a direction, and the parallel cross-sectional plane is substantially parallel to the pressure sensing layer; and
a control unit controlling a clipping force of the clip according to a plurality of pressure signals of the pressure sensing devices.

15. The clipping apparatus according claim 14, wherein the pressure sensing devices are disposed on the clip in the form of a matrix.

16. The clipping apparatus according claim 15, wherein each pressure sensing device further comprises:
two sandwich boards, wherein the pressure sensing layer is disposed between the sandwich boards, and the sandwich boards are flexible substrates.
